(19) United States
(12) Patent Application Publication
(10) Pub. No.: US 2025/0091596 A1
(43) Pub. Date: Mar. 20, 2025

(54) VOICE-BASED CONTROL METHOD AND VEHICLE

(71) Applicant: AutoX, Inc., Grand Cayman (KY)

(72) Inventor: Jianxiong Xiao, Shenzhen (CN)

(73) Assignee: AutoX, Inc., Grand Cayman (KY)

(21) Appl. No.: 18/890,771

(22) Filed: Sep. 20, 2024

(30) Foreign Application Priority Data
Sep. 20, 2023 (CN) 2023112159287

(51) Int. Cl. B60W 50/08; B60W 50/14; G06T 11/00; G06V 20/58; G06V 20/70; G10L 15/22

(52) U.S. Cl. CPC B60W 50/087; B60W 50/14; G06T 11/00; G06V 20/58; G06V 20/70; G10L 15/22; B60W 2050/146; B60W 2420/40; B60W 2540/21; G10L 2015/223

(57) ABSTRACT

This application provides a voice-based control method for a vehicle including: steps of: when receiving a voice command, recognizing the voice command to obtain a pending voice command; planning vehicle actions of the vehicle based on the pending voice command; constructing a current scene map of the vehicle to obtain a first scene map, and displaying the first scene map to prompt user to confirm or modify the pending voice command to correspondingly generate a confirmation instruction or an invalid instruction, wherein the first scene map is configured to present a scenario in which the vehicle would execute the vehicle actions; when the confirmation instruction is received, controlling the vehicle to execute the voice command; and when the invalid instruction is received, controlling the vehicle to ignore the voice command.

This non-provisional patent application claims priority under 35 U.S.C. § 119 from Chinese Patent Application No. 2023112159287 filed on Sep. 20, 2023, the entire content of which is incorporated herein by reference.

### TECHNICAL FIELD

This application relates to the field of voice recognition technology, particularly to a method and vehicle based on speech control.

### BACKGROUND

In recent years, both domestic and foreign automobile companies have successively introduced various driver assistance systems, and the systems are gradually evolving to be more user-friendly and intelligent. For instance, advancement in voice recognition technology have enabled the vehicles to perform driving based on user' voice commands. However, the current technologies have limitations. Specifically, the recognition results of the vehicle recognition voice commands are confined to a single textual representation, making it difficult to intuitively anticipate the intended execution effect. Furthermore, the accuracy of voice recognition plays a pivotal role in determining the recognition results. In cases where there is voice recognition error, the vehicle directly executes user' commands without allowing the user to assess the feasibility of their voice commands, posing significant risks to driving safety.

### SUMMARY

To address the aforementioned technical challenges, there are a voice-based control method and a vehicle are provided.

Firstly, there is provided with a voice-based control method for a vehicle includes steps of: recognizing the voice command to obtain a pending voice command when receiving the voice command; Plan the actions of the vehicle based on the pending voice commands; Construct a current scene map of the vehicle, obtain a first scene map, and display it for user to confirm or correct the pending voice commands based on the first scene map to generate corresponding confirmation or invalid instruction. The first scene map is configured to display the scene where the vehicle executes the action; When receiving a confirmation instruction, control the vehicle to execute the voice command; When receiving a invalid instruction, render the voice command invalid.

Secondly, there is also provided with a vehicle, including

The above method and vehicle based on voice control, both based on voice control, recognize the commands to plan the vehicle's actions, and further construct a scene map, and display it to user allowing the user to confirm or correct the voice commands based on the scene map. When the confirmation instruction is received, the vehicle is controlled to execute the voice command. Conversely, if an invalid voice instruction is received, the voice command deemed in invalid. This application does not rely solely on the feasibility of the user's voice itself, but rather on the user's ability to assess the feasibility of their input voice through the generated scene map after inputting the voice. This ensures the feasibility and accuracy of the voice-controlled instruction executed by the vehicle, ultimately safeguarding the user's driving safety.

### BRIEF DESCRIPTION OF THE DRAWINGS

In order to provide a clearer explanation of the embodiments or technical solutions in the present application or prior art, a brief introduction will be given below to the accompanying drawings required in the embodiments or prior art description. It is evident that the accompanying drawings in the following description are only some embodiments of the present application. For those skilled in the art, other accompanying drawings can be obtained based on the structures shown in these drawings without creative labor.

FIG. 1 is a flowchart of a voice-based control method for a vehicle provided in accordance with an embodiment.

FIG. 2 is a flowchart of the sub-steps of the step S103 shown in FIG. 1.

FIG. 3 is a first flowchart of the sub-steps of the step S104 shown in FIG. 1.

FIG. 4 is a second flowchart of the sub-steps of the step S104 shown in FIG. 1.

FIG. 5 is a first flowchart of the sub-step of the step S105 shown in FIG. 1.

FIG. 6 is a second flowchart of the sub-step of the step S105 shown in FIG. 1

FIG. 7 is a flowchart of the voice-based control method for the vehicle provided in accordance with a second embodiment.

FIG. 8 is a schematic diagram of the vehicle in accordance with an embodiment.

FIG. 9 is a block diagram of a voice-based control vehicle provided in accordance with an embodiment.

FIG. 10 is a schematic diagram of the first scene provided accordance with an embodiment.

FIG. 11 is a schematic diagram of the second scene of the first scenario accordance with an embodiment

The implementation, functional characteristics, and advantages of the purpose of this application will be further explained in conjunction with the embodiments, with reference to the accompanying drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first”, “second”, “third”, “fourth”, etc. (if any) in the specification and claims of this application, as well as the accompanying drawings, are configured to distinguish similar planning objects and do not need to be configured to describe specific order or sequence. It should be understood that the data used in this way can be interchanged in appropriate cases, in other words, the described embodiments are implemented in order other than those illustrated or described here. In addition, the terms “including” and “having”, as well as any variations thereof, may also include other content, such as processes, methods, systems, products, or equipment that include a series of steps or units, not necessarily limited to those clearly listed, but may include other steps or units that are not clearly listed or inherent to these processes, methods, products, or equipment.

It should be noted that the descriptions related to “first”, “second”, etc. in this application are only for descriptive purposes and cannot be understood as indicating or implying their relative importance or implying the quantity of technical features indicated. Therefore, the features limited to “first” and “second” can explicitly or implicitly include one or more of these features. In addition, the technical solutions between various embodiments can be combined with each other, but must be based on what ordinary technical personnel in the art can achieve. When the combination of technical solutions conflicts or cannot be achieved, it should be considered that the combination of such technical solutions does not exist and is not within the scope of protection required by this application.

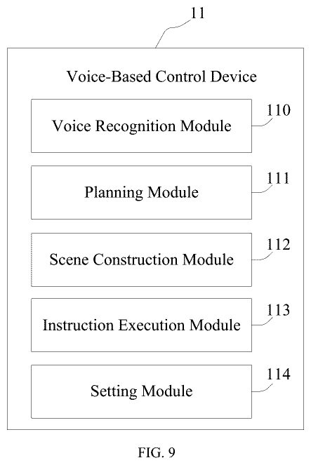

Referring to FIGS. 8 and 9, FIG. 8 takes a car as an example of a vehicle. FIG. 9 shows function block of a voice-based control device employed in the car.

The vehicle 1 can be controlled based on voice commands to execute corresponding driving operations, such as driving in a specified direction or stopping at a designated location. In this embodiment, vehicle 1 includes a vehicle body 10, and a voice-based control device 11 installed on the vehicle body 10. The voice-based control device can be mounted at various positions on the body 10 depending on the specific vehicle model or design. For example, the voice-based control device can be mounted at a center console of the body 10 to facilitate voice control of the vehicle 1 when the vehicle is being driven. The voice-based control device 11 can be an independent device or module mounted on the vehicle 1; or the voice-based control device can also be integrated into one or more existing device or module; or one or more function module of the voice-based control device can be performed by the existing modules. The operation of the voice-based control device will describe to be performed by a plurality of function modules, thereby facilitating understanding and implementation.

Referring to FIG. 9, the voice-based control device 11 includes a voice recognition module 110, a planning module 111, a scene construction module 112, an instruction execution module 113, and a setting module 114.

The voice recognition module 110 is configured to recognize voice commands to obtain pending voice commands.

The planning module 111 is configured to planning vehicle actions of the vehicle based on the pending voice command.

The scene construction module 112 is configured to construct a current scene map of the vehicle to obtain a first scene map, and display the first scene map prompt user to confirm or modify the pending voice command to generate corresponding confirmation instruction or an invalid instruction.

The instruction execution module 113 is configured to control the vehicle to execute the voice commands, when the confirmation instruction is received; and configured to control the vehicle to ignore the voice command, when the invalid instruction is received.

The setting module 114 is configured to display a confirmation instruction input control and an invalid instruction input control in the first scene map, to remind the user to input the confirmation instruction or the invalid instruction.

In this embodiment, the vehicle 1 is controlled by a voice-based control device 11 installed on the vehicle body 10 to achieve voice control of the vehicle through the voice command. The following will explain how to control the vehicle 1 through the voice command through specific process of the voice-based vehicle control 11.

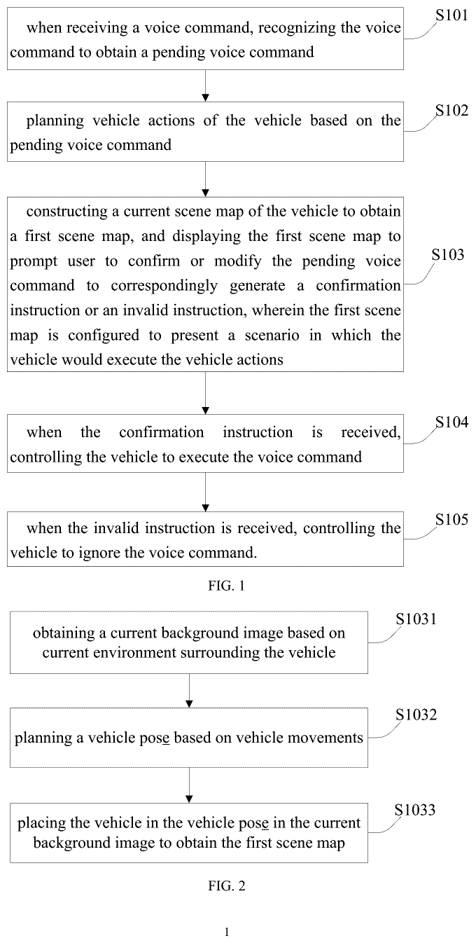

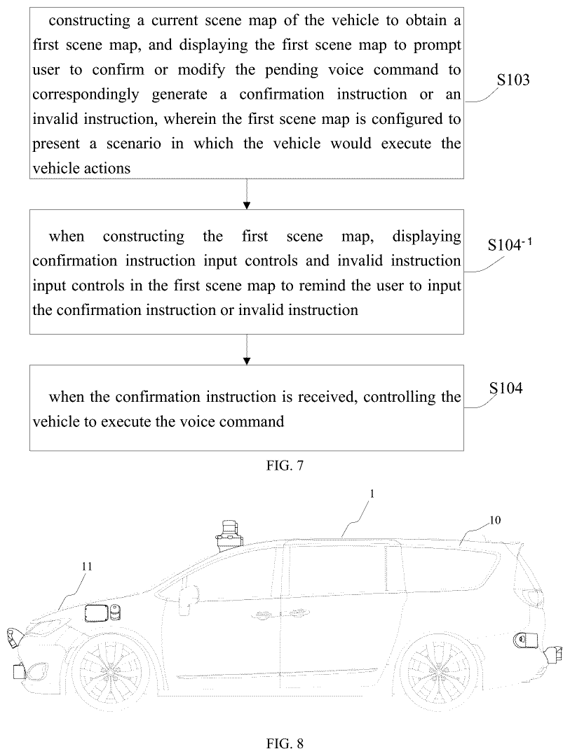

Referring to FIGS. 1 and 7, FIG. 1 illustrates a first flowchart of the voice-based vehicle control method provided in this embodiment, and FIG. 7 illustrates a second flowchart of the voice-based vehicle control method provided in this embodiment.

The voice-based vehicle control method provided includes steps S101-S105.

In the step S101, when a voice command is received, the voice command is recognized to obtain a pending voice command.

In detail, in the step S101, the voice command is received from a voice device (not shown) connected to the voice recognition module 110 to input the voice command, input by the user, to the vehicle 1. The voice device is a component such as microphones that enables the user to input the voice commands. After receiving the voice command input by the user, the voice recognition (not shown in the figure) located on the vehicle body 10 is connected to the voice recognition module 110 to recognize the voice commands and obtain the pending voice commands.

It can be understood that before the voice recognition is performed, it is necessary to pre-train the voice recognition engine with language related to the vehicle driving, so that the voice recognition engine can extract some or all voice commands corresponding to the language related to the driving of the vehicle 1 from the voice commands thereby obtaining the pending voice commands. In this embodiment, the pending voice commands refers to a set of commands classified based on movements of the vehicle 1 in the voice commands corresponding to the language related to vehicle driving. The pending voice commands contain different categories of voice commands. For example, when the vehicle 1 travels from a current position to a target position based on the current position and the target position, which correspond to the current environment of the vehicle 1, the pending voice commands obtained through the voice recognition engine are classified into lane switching commands, driving direction switching commands, vehicle speed adjustment commands, etc..

In this embodiment, the voice recognition engine performs language training related to the vehicle driving based on the instruction classified based on the vehicle driving. Specifically, the voice recognition engine can feed predetermined sets of different voice commands and corresponding sets of different vehicle driving records into the voice recognition engine to train a relation-ship between the voice commands and the driving situations of the vehicle 1 in the vehicle driving records. At the same time, it can train the relation-ship between the voice commands related to the driving of vehicle 1 in the vehicle driving records and the execution situation of the corresponding components of vehicle 1, thereby obtaining the category of the voice commands contained in the pending voice commands. In addition, the voice commands collected by the voice device can construct specific implementation scenarios for the driving of vehicle 1. For example, the voice command collected by the voice device is “switch to the rightmost lane at a speed of claim 60 kilometers per hour and drive to the right ahead.”. This voice command indicates that a purpose of the user input this voice command is to control vehicle 1 to travel in the specified direction at the specified speed, and to pay attention to lane switching during driving. This voice command includes vehicle speed adjustment commands, vehicle lane switching commands, vehicle driving direction switching commands, etc. After recognizing the above categories of voice commands through the voice recognition engine, the specific categories of the pending voice commands are: the vehicle speed adjustment command: adjust from the current speed to a speed of claim 60 kilometers per hour; the vehicle lane switching command: switch from the current lane to the rightmost lane; vehicle driving direction switching command: switch from the current direction to the right front. The above categories of the voice commands and voice commands are only examples of this embodiment, and are not restrictions on the categories of the voice commands and the voice commands in this embodiment. They will not be elaborated here.

In some embodiments, a voice component with a plurality of predetermined driving instructions pre-stored (not shown in the figure) is added to the vehicle body 10 according to user's driving needs, to cooperate with the voice device to quickly input voice command to the vehicle body 10. For example, the voice component can be added to the vehicle body 10 to store information such as “vehicle obstacle avoidance” that expresses the obstacle avoidance achieved by the vehicle 1 during driving. After inputting the voice command, the information can be quickly and directly inputted through the voice component. In other embodiments, a display component can also be added to the vehicle body 10 to display the voice command specifications related to the voice command format when inputting the voice commands to the voice device, reminding user how to input the voice commands that can be quickly recognized by the vehicle 1. This facilitates the rapid recognition of voice commands by the voice recognition engine, reduces the attention required for the user to input the voice command, and focuses more attention on the driving of vehicle 1, thereby improving the safety of the user driving vehicle 1.

In the step S102, vehicle actions are planed based on the pending voice command.

In detail, in the step S102, after obtaining the pending voice command through the voice recognition engine, it is necessary to read the content contained in the pending voice command according to the category of the voice command, in order to plan the user's expected driving situation for vehicle 1, that is, the vehicle actions, according to this content. It can be understood that there are differences in the pending voice commands corresponding to different categories of pending voice commands. For example, in the vehicle driving direction switching command, based on the frequency of text information used by the user to control the vehicle driving direction switching through voice, undetermined voice commands indicating driving direction switching are extracted, such as “facing left”, “facing left front (square)”, “facing left rear (square)”, “facing right”, “facing right front (square)”, “facing right rear (square)”, etc. In the vehicle lane switching command, based on the frequency of text information used by the user to control vehicle 1 lane switching through voice, “facing first lane” and “facing second lane” are extracted. Pending voice commands such as “Two lanes to the left (right) side” and “To the leftmost (right) lane” indicate vehicle lane switching. In some embodiments, the planning module 111 is electrically connected to the display component, allowing the actions planned by the planning module 111 to be transmitted to the display component and displayed for the user to obtain the expected display image of vehicle 1 when driving according to the pending voice commands, which facilitates the user's subsequent feasibility judgment of the voice commands.

It can be understood that not all voice commands contain valid pending voice commands, that is, voice commands have certain invalid voice commands. Before planning the action of vehicle 1, it is necessary to remove voice commands that only contain invalid pending voice commands and prompt user to input voice commands that meet the requirements according to the voice command specifications, in order to simplify and refine the planning of vehicle actions.

In the step S103, a current scene map of the vehicle is constructed to obtain a first scene map and display the first scene map, which is displayed to prompt the user to confirm or modify the pending voice command to correspondingly generate a confirmation instruction or an invalid instruction, wherein the first scene map is configured to present a scenario in which the vehicle would execute the vehicle actions.

In detail, in the step S103, the first scene map is configured to illustrate the scene where vehicle 1 executes the vehicle actions. After planning the vehicle actions, an expected display image of the vehicle 1 can be obtained when driving according to the pending voice commands. In this embodiment, the expected display image is only obtained through pending voice commands and does not take into account the current environment of the vehicle 1. That is to say, the expected display image is essentially a simulated image generated based on the voice command, which is not yet sufficient for the user to determine the feasibility of the input voice commands through the expected display image. Therefore, in order for user to confirm or modify the pending voice command and generate corresponding confirmation or invalid instruction, it is necessary to combine the expected display image with the current environment to construct the current scene map of the vehicle 1, and obtain the first scene map to display the scene where vehicle 1 executes actions in the current environment.

Referring to FIG. 2, a flowchart of sub-steps of the step S103 provided in the embodiment, the step S103 includes steps S1031-S1033.

In step S1031, a current background image based on current environment surrounding the vehicle is obtained.

In detail, in the step S1031, the current environment can be sensed through a sensing component (not shown in the figure) located on the vehicle body 10, in order to obtain information about the driving environment of the vehicle 1, including information on obstacles and other factors that may interfere with the driving of the vehicle 1 within a sensing range of the vehicle 1. The current background image corresponds generated accurately represents the environment as seen from the perspective of the vehicle 1, providing a true representation of the vehicle's current environment to the user, so that the user can make accurate judgments on the first scene map for future. In this embodiment, the sensing components include a LiDAR, a camera, a temperature sensor, etc. It can be understood that the current background image also includes the current position of vehicle 1, so that in the subsequent construction of the first scene map, the current position of vehicle 1 can be used as a reference point for constructing the first scene map, making the constructed scene map more realistic and accurate.

In the step S1032, a vehicle pose is planned based on vehicle movements.

In detail, in the step S1032, the vehicle pose refers changes in the vehicle body status of the vehicle 1 or a usage status of components or functions in the vehicle 1, when executing voice commands. In this embodiment, the vehicle pose can undergo corresponding state changes based on the category of the pending voice command, such as turning of the steering wheel of vehicle 1 during the direction switching or the lane switching, or it could reflect the usage of vehicle functions such as obstacle avoidance while the vehicle 1 is driving in the current direction.

In the step S1033, the vehicle in the vehicle pose is placed in the current background image to obtain the first scene map.

In detail, in the step S1033, after obtaining the vehicle pose, the planned vehicle actions are correspondingly displayed within the current background image based on the category of the pending voice commands and the current background image, in order to display the scene map of the vehicle actions combined with the current background image, which is the first scene map. After constructing the first scene map, the first scene map is displayed to the user through a display component, so that the user can confirm the feasibility of the input voice command through the first scene map. Specific implementation examples will be configured to illustrate how the present application constructs the first scene map.

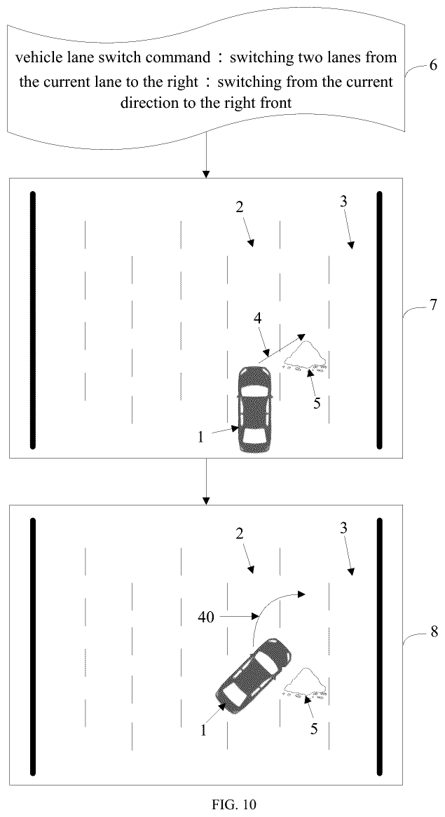

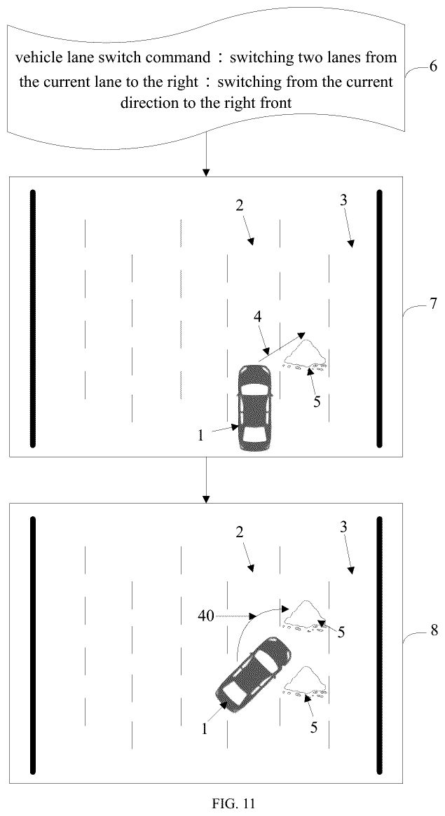

Referring to FIG. 10, FIG. 10 illustrates a first embodiment of the first scene map.

As shown in FIG. 10, in this embodiment, first, after obtaining the pending voice command 6, the vehicle 1 senses background objects around the vehicle 1 through the sensing components to obtain corresponding images such as the image corresponding to an obstacle 5, the image corresponding to the lane in which the vehicle 1 is currently driving, etc. Then, based on the category of the pending voice command 6, the vehicle lane switch command for “switching two lanes from the current lane to the right” and the vehicle driving direction switch command for “switching from the current direction to the right front” are obtained. According to the category of the pending voice command 6, the vehicle actions corresponding to the pending voice command 6, i.e. the vehicle's pose, will be displayed in the current background image 7, that is, the vehicle placed the vehicle 1 in the vehicle pose will be placed in the current background image 7 to obtain the first scene map 8. For example, the switching of lanes from the first lane 2 to the second lane 3, and the switching of vehicle driving direction 4.

In some embodiments, after placing the vehicle in the vehicle pose in the current background image 7, the execution of the pending voice command 6 is monitored based on the first scene map to determine whether the results generated by the pending voice command 6 are feasible. For example, when the vehicle 1 executes the pending voice command 6, the driving direction of the vehicle 1 changes from a vehicle driving direction 4 to a simulated driving direction 40. At this time, when controlling the vehicle 1 to drive in the simulated driving direction 40, it is necessary to monitor whether the simulated driving direction 40 will collide with the obstacle 5, that is, to monitor whether the vehicle is feasible to drive according to the pending voice command 6.

Referring to FIG. 7, when the first scene map is constructed, the voice-based control method for the vehicle also includes step S104⁻¹.

In the step S104⁻¹, when the first scene map is constructed, a confirmation instruction input control and an invalid instruction input control are displayed in the first scene map to remind the user to input the confirmation or the invalid instruction.

In detail, in the step step S104⁻¹, after constructing the first scene map, it is necessary to obtain the confirmation instruction or the invalid instruction to confirm that the voice command is feasible, or to confirm that the voice command is not feasible and requires correction. In this embodiment, after constructing the first scene map, the setting module will display the confirmation instruction input control and the invalid instruction input control in the first scene map to remind the user to input the corresponding instruction and receive the confirmation instruction or the invalid instruction that the user inputs. Specifically, confirming that the instruction input control and correcting the instruction input control are controls with a certain degree of transparency, in order to enable user to judge whether the voice commands are feasible based on the first scene map without being visually affected by the instruction input control. In some embodiments, when the display component can display a sufficiently large screen, the confirmation instruction input control and the invalid instruction input control may also be displayed on the display component other than the first scene map, without being displayed on the first scene map.

In the step S104, when the confirmation instruction is received, the vehicle is controlled to execute the voice command.

In detail, in the step S104, when the user confirms that the input voice command is feasible based on the first scene map, correspondingly, the user will input the corresponding confirmation instruction. At this point, the input voice command is the actual voice command that the vehicle 1 needs to execute, that is, the vehicle 1 will drive according to the voice command.

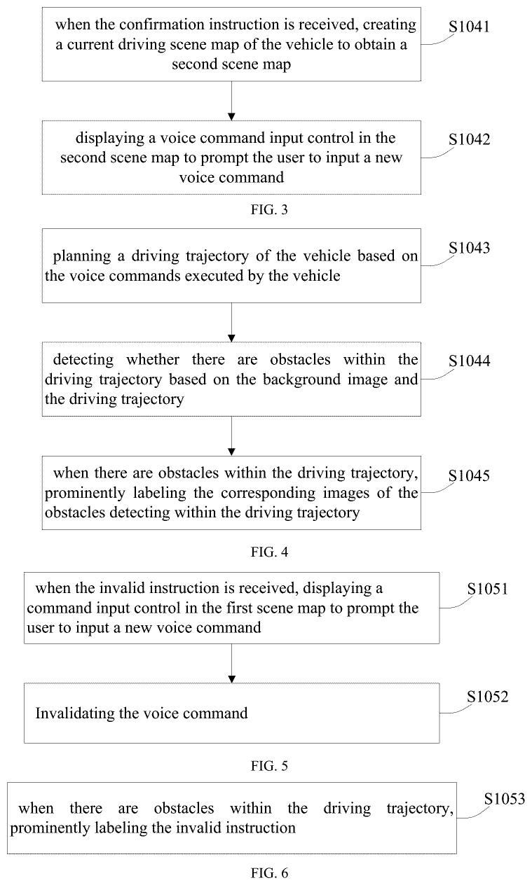

Referring to FIG. 3, a first flowchart of the-sub-steps of the step S104 provided in the embodiment. When the confirmation instruction is received, the vehicle is controlled to execute the voice commands includes steps S1041-S1042.

In the step S1041, when the confirmation instruction is received, the current driving scene map of the vehicle is constructed to obtain a second scene map.

In detail, in the step S1041, the second scene map is displayed on the display component, and is a scene map generated by combining the current background image with actions performed by the vehicle 1, to show actual driving situation of the vehicle 1 when executing actions according to voice commands. It can be understood that the second scene map will be continuously created as the vehicle 1 drives according to the actions contained in the voice commands, in order to continuously judge the execution of the voice commands by the vehicle 1.

In the step S1042, a voice command input control is displayed in the second scene map to prompt the user to input voice commands.

In the step S1042, in order for the user to determine the situation of the vehicle 1 executing the voice commands based on the second scene map, while creating the second scene map, a voice command input control is set and displayed in the second scene map to prompt the user to input the voice command. For example, an executed instruction input to indicate continuing the vehicle 1 to execute the current voice command, and a stop command input to indicate controlling the vehicle 1 to stop executing the current voice command. The voice command input control is a control with a certain degree of transparency, which allows the user to judge the execution of the voice commands in vehicle 1 based on the second scene map without being visually affected by the voice command input control. In some embodiments, when the display component is capable of displaying a sufficiently large screen, the voice command input control may also be displayed on a screen other than the second scene map on the display component.

In some embodiments, the display of the first and second scene maps can be adjusted appropriately based on the specifications of the display components. For example, when the display component is large enough, the first and second scene maps can be displayed simultaneously on the display component. At the same time, the transparency of the first and second scene maps can also be adjusted appropriately based on the functionality currently used by the user. For example, when the user is viewing the second scene map to confirm the execution of voice commands by the vehicle 1, they can either adjust the first scene map to have a certain degree of transparency or complete transparency, or place the first scene map below the second scene map for overlay. In other embodiments, when the display of the scene map is limited by the specifications of the display components, the scene map can be first retained in a storage module located on the vehicle body (not shown in the figure), and then the scene map that the user has not currently viewed can be directly deleted. When the deleted scene map needs to be viewed, the deleted scene map can be reloaded through the storage module.

Referring to FIG. 4, a second flowchart of sub-steps of the step S104 provided in the embodiment. In this embodiment, when a confirmation instruction is received, the voice-based control method for the vehicle further includes steps S1043-S1045.

In the step S1043, a driving trajectory is planed based on the voice command executed by the vehicle.

In detail, in step S1043, the driving trajectory includes the first image representing the current position of the vehicle 1 and the driving situation of the vehicle 1 in the current scene map of vehicle 1.

In the step S1044, there is determined whether there are obstacles on the driving trajectory based on the background image and driving trajectory.

In detail, in the step S1044, the obstacles refer to a background objects located on the driving trajectory. In this embodiment, the vehicle 1 needs to continuously judge the execution status of the voice commands while driving according to them. Specifically, due to the limitation of the sensing components, it is difficult for the vehicle 1 to ensure that it can fully obtain the background objects around the vehicle 1 when executing the voice command. When there are obstacles on the driving trajectory, it is necessary to control the vehicle 1 to stop executing the current voice command through the voice command input control, and adjust the voice command in a timely manner based on the relationship between the driving trajectory and the position of the obstacles.

In the step S1045, when there are obstacles in the driving trajectory, the corresponding images of the obstacles are prominently labeled.

In detail, in the step S1045, after on detecting obstacles on the driving trajectory, the vehicle 1 needs to notify the user of the presence of obstacles, allowing the user to promptly adjust the voice commands. To ensure that the user can clearly perceive the obstacles, it is necessary to prominently label the obstacles in the scene map. The label includes but are not limited to highlighting the images corresponding to the obstacles with strobe, using highly recognizable colors to prominently mark the images corresponding to the obstacles, etc.

In the step S105, when the invalid instruction is received, the voice command is invalidated.

In detail, in step S105, when the user confirms that the input voice command is not feasible based on the scene map, the user inputs the invalid instruction. After the invalid instruction is received, the vehicle 1 needs to prompt the user to correct the input voice command with a new voice command to replace the voice command, in order to make the voice command invalid. Specific implementation examples will be configured to illustrate how the present application confirms that the voice command is not feasible based on the scene map.

Referring to FIG. 11, a second embodiment diagram of the first scene map provided in the embodiment.

As shown in FIG. 11, the difference between the second embodiment and the first embodiment is that there is an obstacle 5 when the vehicle 1 is driving in the simulated driving direction 40. In the second embodiment, when vehicle 1 is driving in the direction of vehicle 4, it will collide with the obstacle 5. But when the vehicle 1 drives in the simulated driving direction 40, it will also collide with the obstacle 5. Due to the simulated driving direction 40 being the driving direction corresponding to vehicle 1's execution of pending voice commands, and the presence of the obstacle 5 in this simulated driving direction 40, vehicle 1 will collide with the obstacle 5 when driving according to this voice command. Therefore, according to FIG. 8 of the first scenario, it is confirmed that it is not feasible for vehicle 1 to drive according to voice commands.

Referring to FIG. 5, a first flowchart of sub-steps of the step S105 provided in the embodiment. The step S105 includes steps S1051-S1052.

In the step S1051, when the invalid instruction is received, the command input control in the first scene map is displayed to prompt the user to input new voice commands.

In detail, in the step S1051, after receiving the invalid instruction, it is necessary to obtained the user's corrected voice command to replace the current voice command. In this embodiment, a command input control is configured to prompt the user to input new voice commands and receive them. Specifically, the instruction input control is a control with a certain degree of transparency, allowing user to determine whether the voice commands are feasible based on the first scene map without being visually affected by the instruction input control. In some embodiments, when the display component is capable of displaying a sufficiently large screen, the instruction input control may also be displayed on a screen other than the first scene map, instead of being displayed on the first scene map.

In the step S1052, the voice command need to be corrected, is invalidated.

In detail, in the step S1052, after the user inputs a new voice command, the new voice command will overwrite the current voice command. At this point, the current voice command is an invalid voice command. In this embodiment, after the voice command is invalid, the vehicle will send an invalid command message to the user through the display component to indicate that the current voice command is invalid, in order to perform invalid processing on the current voice command. It can be understood that the invalid information of the instruction can be displayed directly through the display component, or it can be reminded to the user that the input voice instruction is invalid through voice devices.

Referring to FIG. 6, a second flowchart of sub-steps of the step S105 is provided in the embodiment. In this embodiment, when the invalid instruction is received, the step 105 further includes step S1053.

In the step S1053, when there are obstacles on the driving trajectory, the invalid instruction is prominently labeled.

In detail, in the step S1053, the presence of the obstacles in the driving trajectory can be caused by the presence of the obstacles in the corresponding driving direction after the vehicle 1 drives according to the pending voice command, or by the discovery of the obstacles in the corresponding driving trajectory when vehicle 1 drives according to the actions contained in the voice command. It can be understood that when there are the obstacles on the driving trajectory, it is not feasible for the vehicle 1 to execute the current voice command, that is, the current voice command needs to be corrected. Therefore, to prompt the user to correct the voice command, the instruction execution module 113 prominently marks the received invalid instruction after receiving them. The eye-catching signs for the invalid instruction include but are not limited to highlighting the invalid instruction, using highly recognizable colors to prominently mark the invalid instruction, and prompting them simultaneously through voice devices and display components.

In the above embodiment, after receiving the voice command, the vehicle plans actions are planned by first recognizing the voice command, constructing a scene map and displaying it for the user. This allows the user to confirm or correct the voice command based on the scene map. When the confirmation instruction is received, the vehicle is then controlled to execute the voice command, and when the invalid instruction is received, the voice command is invalidated. This application does not rely on the feasibility of the user's voice itself, but rather on the user's ability to judge the feasibility of their input voice through the generated scene map after inputting the voice, achieving the feasibility and accuracy of the user controlling the vehicle to execute instruction through voice, and ensuring the user's driving safety.

It should be noted that the above implementation examples are only for description and do not represent the advantages or disadvantages of the embodiments. And the terms “including”, “including”, or any other variation thereof in this article are intended to encompass non exclusive inclusion, such that a process, device, item, or method that includes a series of elements not only includes those elements, but also includes other elements not explicitly listed, or also includes elements inherent to such process, device, item, or method. Without further limitations, the element limited by the statement “including a . . . ” does not exclude the existence of another identical element in the process, device, item, or method that includes that element.

The above are only preferred embodiments of this application and are not intended to limit the scope of the patent. Any equivalent structure or equivalent process changes made using the description and drawings of this application, or directly or indirectly applied in other related technical fields, are equally included in the scope of patent protection of this application.

1. A voice-based control method for a vehicle, comprising:
when receiving a voice command, recognizing the voice command to obtain a pending voice command;
planning vehicle actions of the vehicle based on the pending voice command;
constructing a current scene map of the vehicle to obtain a first scene map, and displaying the first scene map to prompt user to confirm or modify the pending voice command to correspondingly generate a confirmation instruction or an invalid instruction, wherein the first scene map is configured to present a scenario in which the vehicle would execute the vehicle actions;
when the confirmation instruction is received, controlling the vehicle to execute the voice command; and
when the invalid instruction is received, controlling the vehicle to ignore the voice command.

2. The voice-based control method for the vehicle of claim 1, wherein constructing a current scene map comprising:
obtaining a current background image based on current environment surrounding the vehicle;
planning a vehicle pose based on vehicle movements; and
placing the vehicle in the vehicle pose in the current background image to obtain the first scene map.

3. The voice-based control method for the vehicle of claim 1, wherein when the confirmation instruction is received, controlling the vehicle to execute the voice command, comprises:
when the confirmation instruction is received, creating a current driving scene map of the vehicle to obtain a second scene map; and
displaying a voice command input control in the second scene map to prompt the user to input a new voice command.

4. The voice-based control method for the vehicle of claim 3, e further comprising:
planning a driving trajectory of the vehicle based on the voice commands executed by the vehicle;
detecting whether there are obstacles within the driving trajectory based on the background image and the driving trajectory; and
when there are the obstacles within the driving trajectory, prominently labeling the corresponding images of the obstacles detecting within the driving trajectory.

5. The voice-based control method for the vehicle of claim 1, wherein when the invalid instruction is received, controlling the vehicle to ignore the voice command, including:
when the invalid instruction is received, displaying a command input control in the first scene map to prompt the user to input a new voice command; and
Invalidating the voice command.

6. The voice-based control method for the vehicle of claim 1, further comprising:
when constructing the first scene map, displaying confirmation instruction input controls and invalid instruction input controls in the first scene map to remind the user to input the confirmation instruction or invalid instruction.

7. The voice-based control method for the vehicle of claim 6, wherein when the invalid instruction is received, voice-based control method for the vehicle further comprises:
when there are obstacles within the driving trajectory, prominently labeling the invalid instruction.

8. A vehicle, comprises:
a memory, storing program instruction; and
a processor, executing the program instruction to enable the vehicle to perform a voice-based control method for the vehicle, the voice-based control method for the vehicle comprising:
when receiving a voice command, recognizing the voice command to obtain a pending voice command;
planning vehicle actions of the vehicle based on the pending voice command;
constructing a current scene map of the vehicle to obtain a first scene map, and displaying the first scene map to prompt user to confirm or modify the pending voice command to generate corresponding confirmation instruction or an invalid instruction, wherein the first scene map is configured to present a scenario in which the vehicle would execute the vehicle actions;
when the confirmation instruction is received, controlling the vehicle to execute the voice command; and
when the invalid is generated, controlling the vehicle to ignore the voice command.

9. The vehicle of claim 8, wherein constructing a current scene map comprising:
obtaining a current background image based on current environment surrounding the vehicle;
planning a vehicle pose based on vehicle movements; and
placing the vehicle in the vehicle pose in the current background image to obtain the first scene map.

10. The vehicle of claim 8, wherein when the confirmation instruction is received, controlling the vehicle to execute the voice command, comprises:
when the confirmation instruction is received, creating a current driving scene map of the vehicle to obtain a second scene map; and
displaying a voice command input control in the second scene map to prompt the user to input a new voice command.

11. The vehicle of claim 10, wherein the voice-based control method for the vehicle further comprising:
when constructing the first scene map, displaying confirmation instruction input controls and invalid instruction input controls in the first scene map to remind the user to input the confirmation instruction or invalid instruction.

12. The vehicle of claim 8, wherein when the invalid instruction is received, controlling the vehicle to ignore the voice command, including:
when the invalid instruction is received, displaying a command input control in the first scene map to prompt the user to input a new voice command; and
Invalidating the voice command.

13. The vehicle of claim 12, wherein the vehicle of claim 8 further comprises:
planning a driving trajectory of the vehicle based on the voice commands executed by the vehicle;
detecting whether there are obstacles within the driving trajectory based on the background image and the driving trajectory; and
when there are obstacles within the driving trajectory, prominently labeling the corresponding images of the obstacles detecting within the driving trajectory.

14. The voice-based control method for the vehicle of claim 13, wherein when the invalid instruction is received, the voice-based control method for the vehicle further comprises:
when there are obstacles within the driving trajectory, prominently labeling the invalid instruction.
